(19) United States
(12) Patent Application Publication
(10) Pub. No.: US 2013/0149662 A1
(43) Pub. Date: Jun. 13, 2013

(54) Dental Hygiene System

(71) Applicant: Routh Meloul-Tzubeli, Miami Beach, FL (US)

(72) Inventor: Routh Meloul-Tzubeli, Miami Beach, FL (US)

(21) Appl. No.: 13/765,106

(22) Filed: Feb. 12, 2013

Related U.S. Application Data
(63) Continuation-in-part of application No. 13/398,970, filed on Feb. 17, 2012.
Application No. 13/398,970 is a continuation of application No. 12/253,049, filed on Oct. 16, 2008, now abandoned.

(51) Int. Cl. A61C 17/00

(52) U.S. Cl. CPC A61C 17/00
USPC 433/80; 173/218; 137/513.3

(57) ABSTRACT

A system for providing water powered mechanical articles is provided where said system has
a selector valve operatively associated with a water inlet;
a containment tube having therein a separate water input tube and a separate water discharge tube;
a spooling apparatus for spooling said containment tube;
a hand-held selector valve having incorporated therein selection means for utilizing said system further constructed and arranged such that unexpelled water from said valve body is returned through said discharge tube incorporated said containment tube.

This application is a continuation-in-part of U.S. patent application Ser. No. 13/398,970 filed Feb. 17, 2012 which is a continuation of U.S. patent application Ser. No. 12/253,009 filed Oct. 17, 2008 which is a non-provisional of U.S. Provisional Patent Application Ser. No. 60/980,645 filed Oct. 17, 2007, the disclosures of which are incorporated herein by reference in their entirety.

### BACKGROUND OF THE INVENTION

### Field of the Invention

The present invention relates generally to a multi-speed dental flossing system that is not self-contained and does not require refilling. The invention adapts to variable-sized faucets, utilizing an existing water source (such as a bathroom sink) and creating its own pressure levels, so as to hygienically cleanse and protect teeth by providing flossing and irrigation, as well as variable heads for brushing the teeth and cleansing the tongue, in an effort to curb the effects of tooth decay by removing plaque and bacteria caused by food particles left in the mouth after meals.

Oral disease has plagued human beings since the beginning of history. Some researchers claim that examples of a dental floss-like thread have been found between the teeth of ancient human beings. One of the first concrete examples of dental floss was produced at the end of the 19^{th} century and was made of a thin thread of silk.

Later, silk was replaced by nylon thread, which could be produced in greater lengths, consistent diameter, and had better resistance to shredding during the flossing procedure. But it wasn't until dentistry advanced to the stage of detecting bacteria responsible for periodontal disease, that preventive dentistry really took off, which created an increased awareness and desire to better maintain teeth, for health, as well as aesthetic reasons.

Existing flossing techniques, however, are not without their disadvantages. To begin with, commercially available dental floss string can get stuck and/or shredded between the teeth, especially if the individual possesses interdental (smaller) spaces between teeth.

Furthermore, standard dental cleaning devices, while alleviating some of the concerns of the flossing threads, utilize a self-contained water supply as a cleansing agent, propelling it over the teeth and gum line.

The problem is these devices need to be regularly refilled with water, which places a burden on the individual's dental hygiene routine by creating the added step of replenishing the unit, which can lead to an increase in prep time and a shortened amount of cleansing, which in turn results in deficient dental hygiene.

Moreover, standard flossing and water pick devices tend to be limited in the amount of pressure provided to the water jet. This can be a significant issue in situations where less water pressure is required, as in the case of a child, or higher pressures are necessitated, by adults with more serious cleaning issues.

Another disadvantage of existing flossing devices and water picks is that they concentrate on the teeth alone and do not offer the option of interchangeable dental heads for cleaning other areas inside the mouth, such as the tongue, which can be a haven for harmful bacteria.

Overlooking care to other areas inside the mouth can also lead to serious dental health issues that should be addressed as part of any preventative regimen.

Accordingly, there is an established need for a multi-speed dental flossing system that, in addition to being constructed in a self-contained manner and capable of calibrating its own water pressure, can also be adapted to different sized faucets, as well as containing multiple accessories, such as a tongue cleaner/scraper and toothbrush, to augment the hygienic effect of the dental cleaning procedure.

Additionally, it is contemplated that a system can be provided whereby the system can be incorporated to use an existing water inlet. Said existing water inlet operatively associated with a base system. Base system will preferably allow for the spooling of incorporated hoses and will provide an outlet to a hand-held dental device whereby water is selectively used for either irrigation or the turning of a mechanical turbine.

### SUMMARY OF THE INVENTION

The present invention is directed to a multi-speed dental flossing system. The flosser of the present invention is configured for facilitating dental care by providing a more versatile unit that takes into consideration hygienic issues related to all aspects of dental maintenance.

An object of the present invention is to provide a multi-speed dental flossing system those functions by way of adaptation to existing water sources, such as faucets.

A further object of the present invention is to provide a multi-speed dental flossing system that provides variable pressure control, depending on the amount of force required during oral hygiene maintenance.

Another object of the present invention is to provide multi-speed dental flossing system that incorporates multiple flossing heads, including a toothbrush and a tongue cleaner/scraper.

In accordance with a first aspect of the invention, a multi-speed dental flossing system is provided comprising an adapter that connects to existing faucets to supply water to the unit.

In accordance with a second aspect of the invention, a mouthwash receptacle can be connected to the faucet adapter to supplement the water supply with additional cleansing elements.

In accordance with a third aspect of the invention, a 45 degree flossing head is provided for maximum hygienic effect.

In accordance with a fourth aspect of the invention, optional heads are provided for brushing teeth, as well as scraping particles and debris from the tongue.

In accordance with a fifth aspect of the invention, variable pressure flossing heads are provided that graduate the amount of water pressure supplied to the unit by varying the size of the openings on the heads, thus allowing different levels of force to be expended into the multi-speed dental flossing system, depending on the amount required by the individual.

In one embodiment, the present invention is a system for providing water powered mechanical articles, said system comprising:

a selector valve operatively associated with a water inlet;

a containment tube having therein a separate water input tube and a separate water discharge tube;

a spooling apparatus for spooling said containment tube;

a hand-held selector valve having incorporated therein selection means for utilizing said system further constructed and arranged such that unexpelled water from said valve body is returned through said discharge tube incorporated said containment tube.

The system poppet valve controls the output of water from said water input tube such that said output is selected from either a steady stream or a pulsated stream.

The output is directed to said outlet device constructed and arranged to provide water to the oral cavity of a mammal.

The hydraulic rotary turbine is operatively associated with a mechanical tool and the motion of said turbine provides mechanical motion for said tool.

The mechanical motion of said tool includes motion provided to a mechanical toothbrush head.

These and other objects, features, and advantages of the present invention will become more readily apparent from the attached drawings and the detailed description of the preferred embodiments, which follow.

### BRIEF DESCRIPTION OF THE SEVERAL VIEWS OF THE DRAWING

FIG. 1 is a right perspective view of the multispeed dental flossing system showing all of the components except for the optional heads.

FIG. 2 is a front perspective view of the adapter before it is placed on the faucet.

FIG. 3 is a front view of the adapter.

FIG. 4 is a bottom plan view of the toothbrush head.

FIG. 5 is a front perspective view of the tongue Cleaner.

FIG. 6 is a right perspective view of the multiple pressure heads.

FIG. 7 is a right side view of the flossing head showing the 45 degree angle.

FIG. 8 is a perspective view of the components of the present invention.

FIG. 9 is an enlarged view of the wand component of the present invention.

FIG. 10 is a schematic of the water flow and the control valves according to the present invention.

FIG. 11 is a partial sectional view of the water containment system whereby two tubes are contained inside a third larger tube.

FIG. 12 is partial sectional view of through the input valve body 906 with the water flow in the closed position.

FIG. 13 is a partial sectional view through the input valve body through 906 with valve 907 shown in the open system.

FIG. 14 is a partial sectional view showing the tube storage spooling system.

FIG. 15 is a partial sectional view through the wand of the present invention showing the rotary motion mechanism.

FIG. 16 is a partial sectional view the wand portion showing the pick mechanism.

FIG. 17 is a partial side view showing the toothbrush and dock of the present invention.

FIG. 18 is an exploded view showing of the toothbrush showing the detachable parts.

FIG. 19 shows the toothbrush of the present invention in a charged position in a dock according to the present invention.

FIG. 20 is a partial sectional view of the toothbrush of the present invention in the charge position in a dock.

FIG. 21 is a partial side view of a brush piece with curved bristle profile according to the present invention.

FIG. 22 is a side view of a brush piece with a curved chisel point bristle according to the present invention.

FIG. 23 is a brush piece with a flat fine bristle.

### DETAILED DESCRIPTION OF THE PREFERRED EMBODIMENT

Shown throughout the figures, the present invention is generally directed towards a multi-speed dental flossing system with interchangeable dental heads, designed specifically to provide users with a practical and efficient means for practicing dental hygiene by providing a versatile structure that takes into consideration variable water pressure, as well as periodontal maintenance.

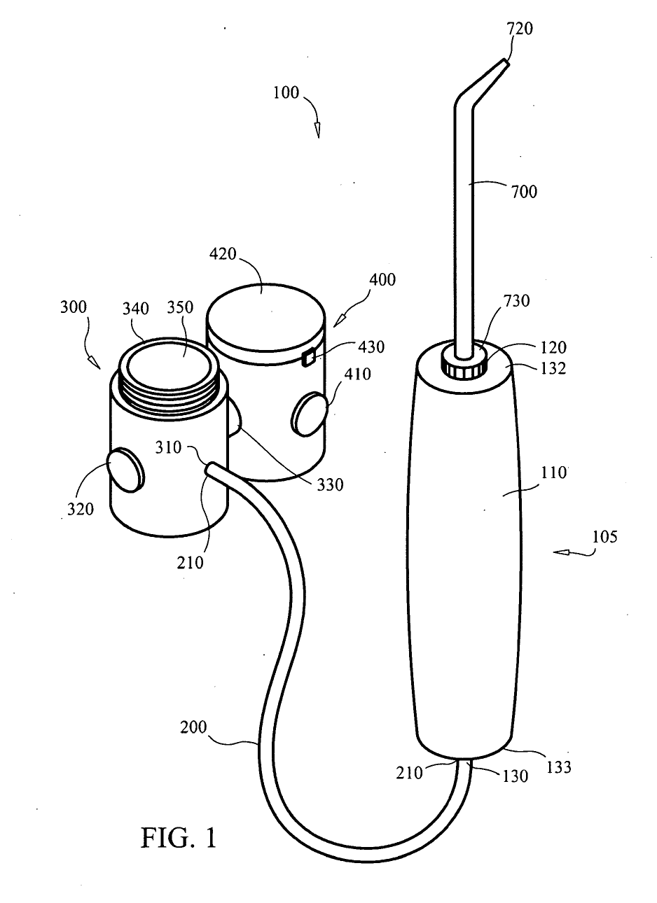

Referring now to FIG. 1, the multi-speed dental flossing system 100 is shown before it has been connected to the faucet 800. The multi-speed dental flossing system 100 is comprised of a handheld base 105 that is grasped by the grip portion 110 with interchangeable dental heads connectable to the handheld base 105.

Located on the base top wall 132 is the interchangeable-head connector 120, which is configured to receive any of the interchangeable dental heads, such as the flossing head 700, as well as the other accessories.

The base bottom wall 133 is non-removably connected to the fluid tube 200, by means of the base-tube connector 210. The fluid tube 200 is, in turn, connected to the faucet adapter 300 by means of the tube receptacle 310.

The faucet adapter 300 is comprised of a faucet cutoff valve 320, a faucet connecting end 340, as well as a fluid chamber 350. The faucet adapter 300, can also be optionally connected to the mouthwash receptacle 400, by means of the adapter-to-mouthwash connector 330. The mouthwash receptacle 400 has its own mouthwash cut-off valve 410, as well as a receptacle lid 420 with a lid clasp 430, to keep its contents secured.

It will be appreciated by those skilled in the art that these structural elements of the present invention may be formed out of natural and synthetic materials, such as plastic, rubber, and combinations thereof, or any of a wide variety of other known materials without departing from the present invention.

Also, the fastening means that joins the faucet adapter 300 to the faucet 800, as well as the flossing heads 700 to the handheld base 105, shall employ any number of methods, including, but not limited to, male and female connectors, screws, fasteners, and the like.

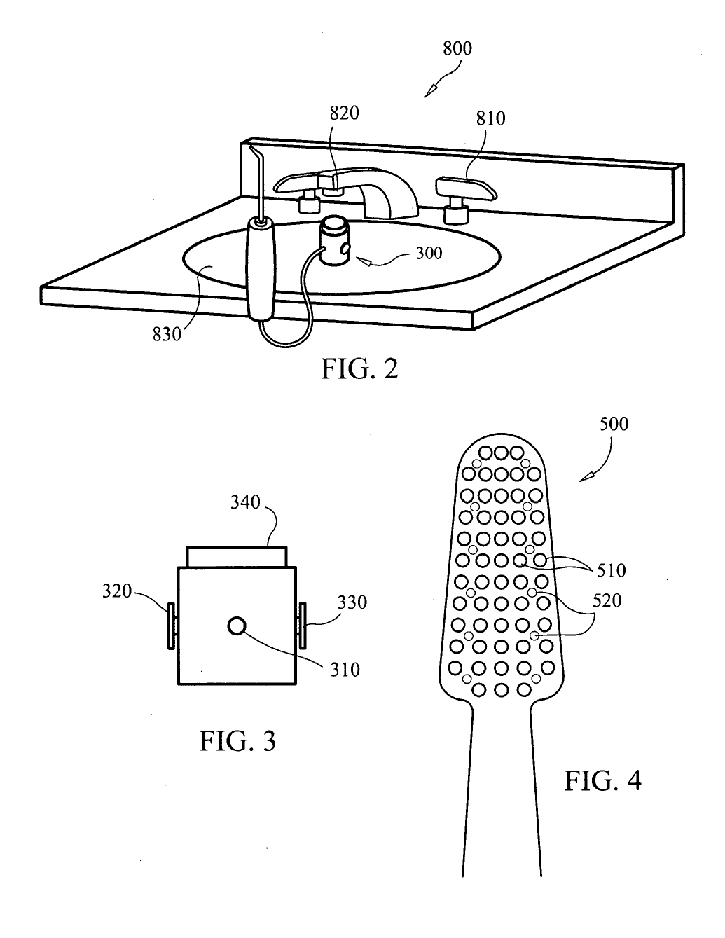

Referring now to FIGS. 2 and 3, the faucet adapter 300 is shown about to be attached to the faucet 800, by means of the spout 820. When the handle 810 of the faucet 800 is turned and engaged, water shoots through the spout 820, through the faucet adapter 300, into the fluid tube 200, through the handheld base 105, and out into the flossing head 700, where it emerges via the distal tip 720. If the faucet cut-off valve 320 is engaged, then the water will instead pour into the sink 830 and bypass the fluid tube 200.

Also, mouthwash can be mixed in with the water, depending on whether or not the mouthwash cut-off valve has been engaged.

If it hasn't, the mouthwash will flow through the mouthwash connector 330, mix with the water, and follow the same path through to the flossing head 700.

Referring now to FIG. 4, another interchangeable dental head, the optional toothbrush head 500 is shown, which features bristles 510 for brushing teeth, as well as water orifices 520 for allowing the water and/or mouthwash to be excreted.

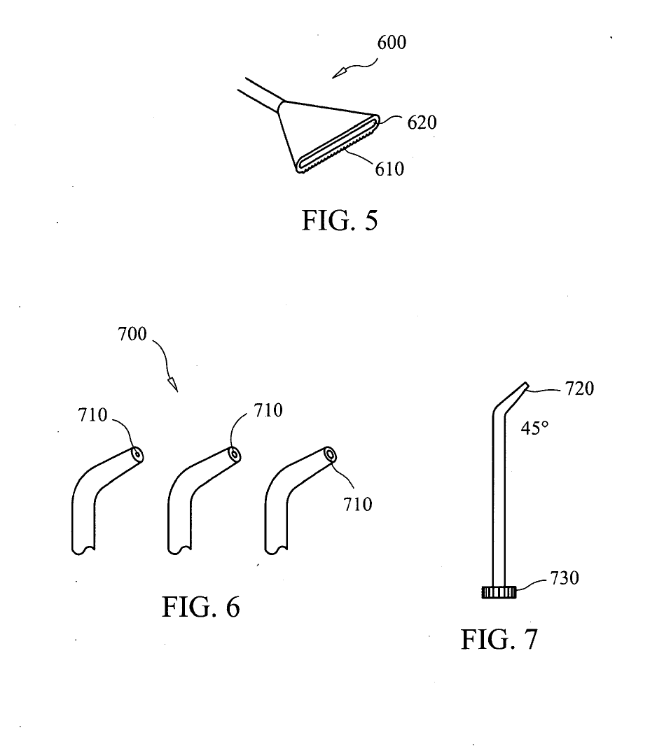

FIG. 5 illustrates yet another interchangeable dental head, the optional tongue cleaner head 600, which contains scraping blades 610 that remove particles from the tongue, and also has a fluid vent 620 to allow for the passage of water and/or mouthwash during the process.

Referring now to FIGS. 6 and 7, a more detailed look at the flossing heads 700 is depicted. The flossing heads 700 contain multi-pressure holes 710 that vary in size and are responsible for regulating the amount of water pressure that flows out the tip 720.

The water pressure emanating from the faucet 800 is much less relevant. It is the multi-pressure holes 710 that determine the amount of force when using the multi-speed dental flossing system.

FIG. 7 illustrates an interchangeable dental head in the form of a 45 degree flossing head, having an open distal tip angled at approximately 45 degrees from the body of the flossing head, providing maximum hygienic effect.

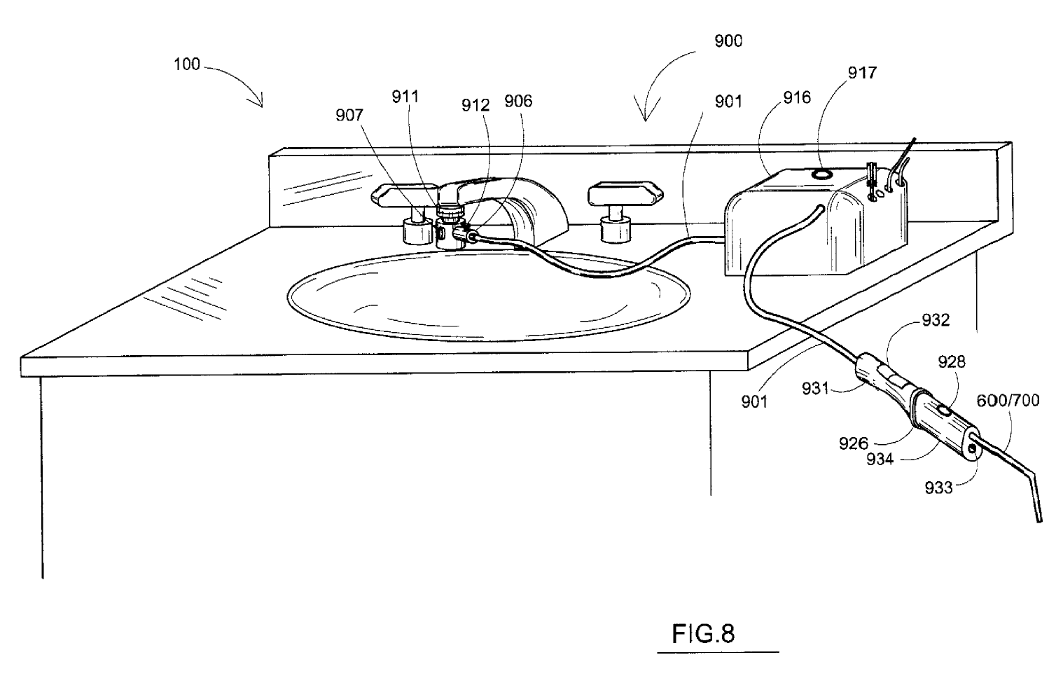

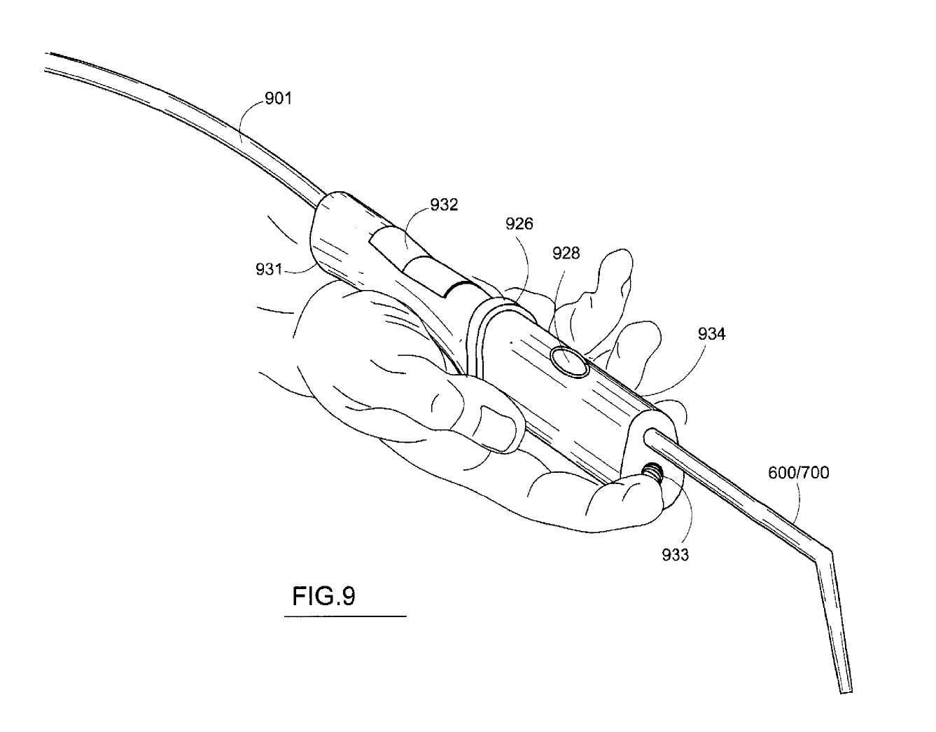

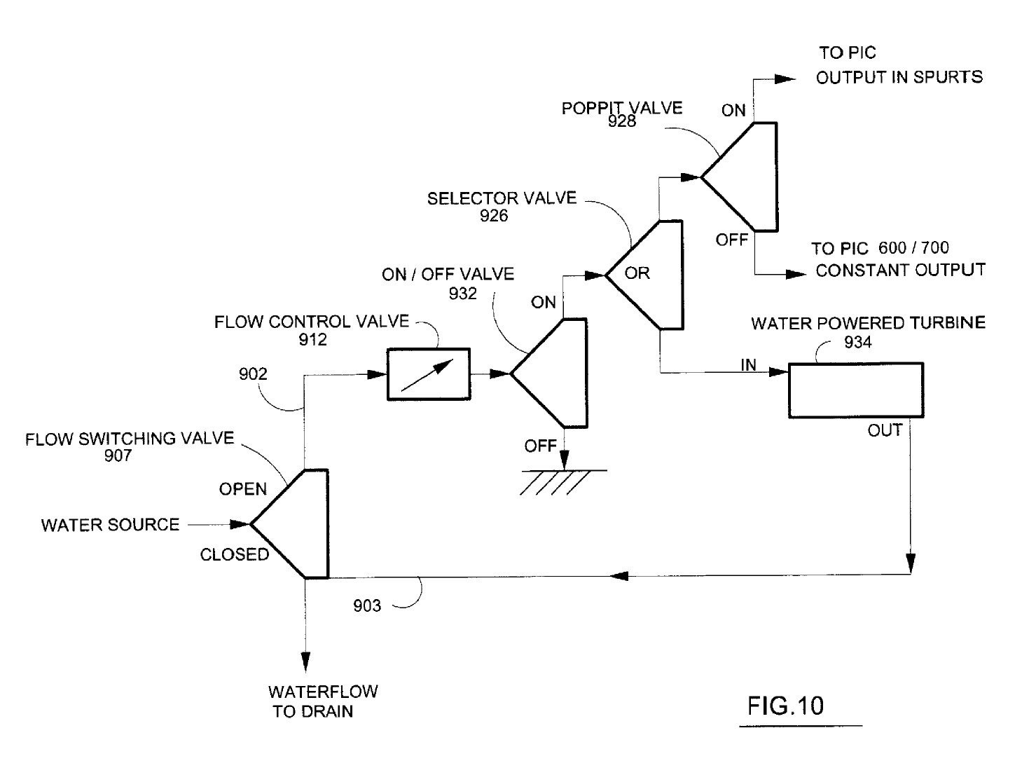

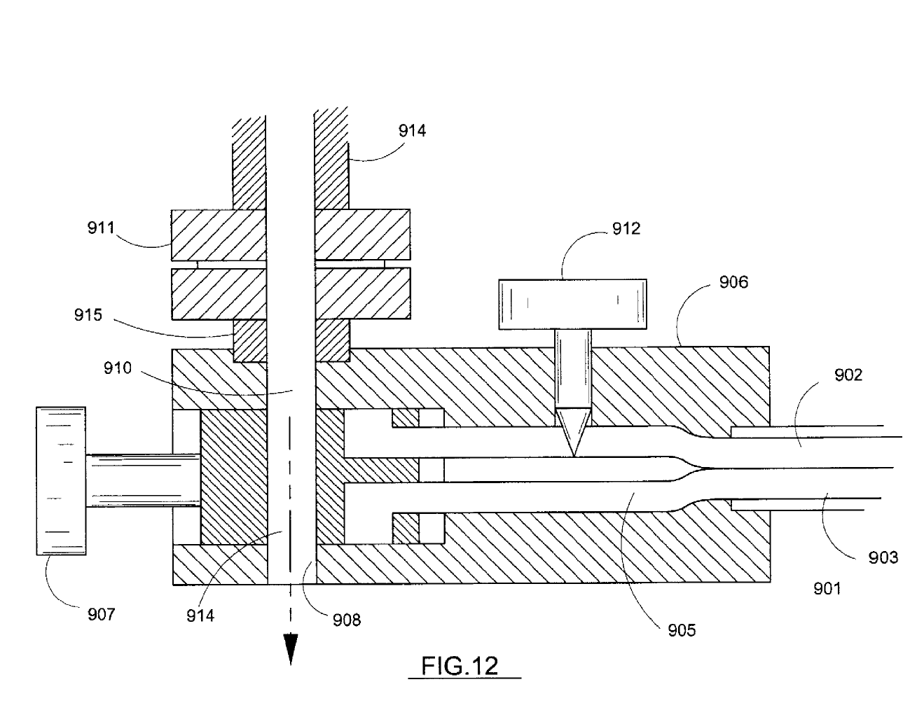

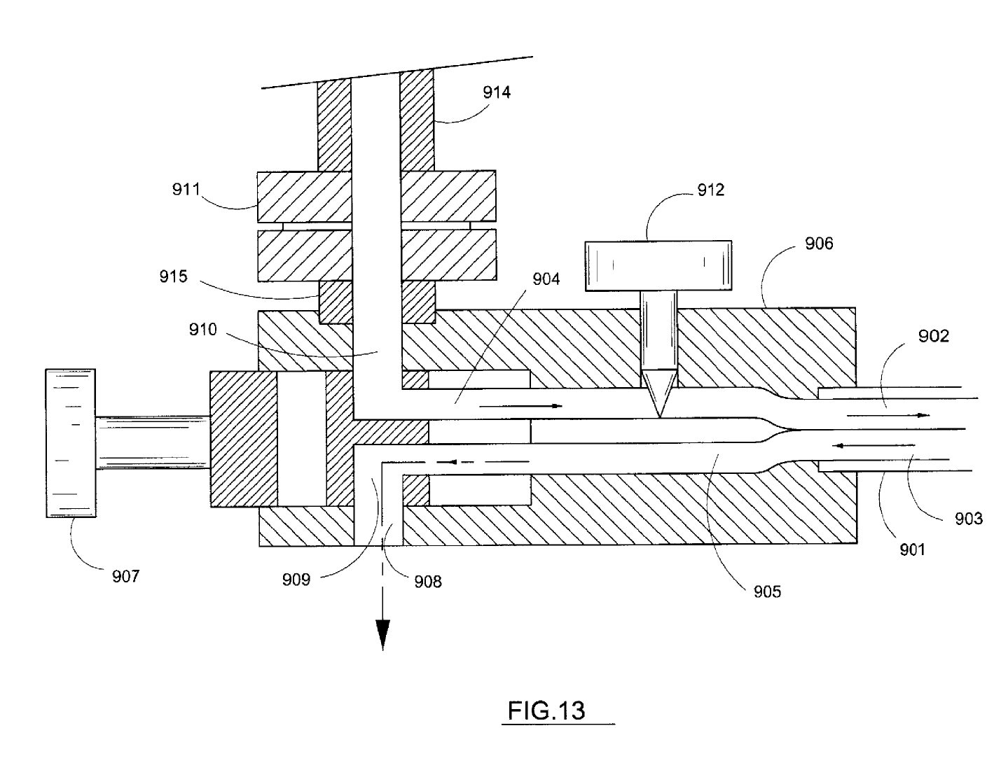

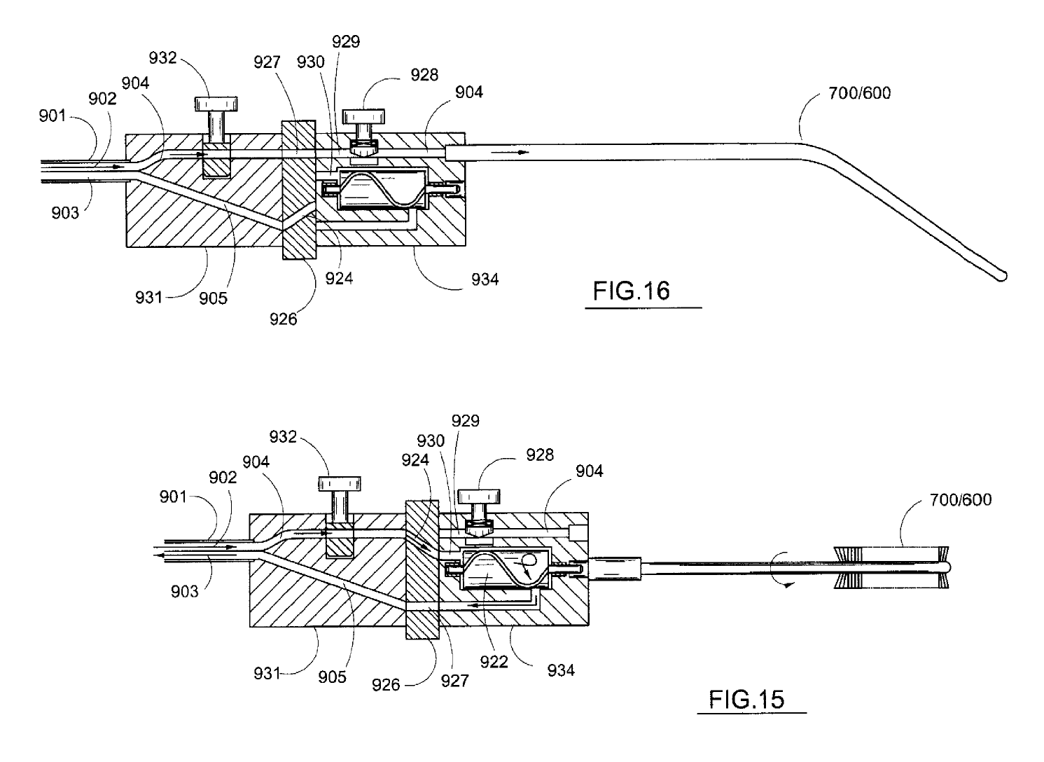

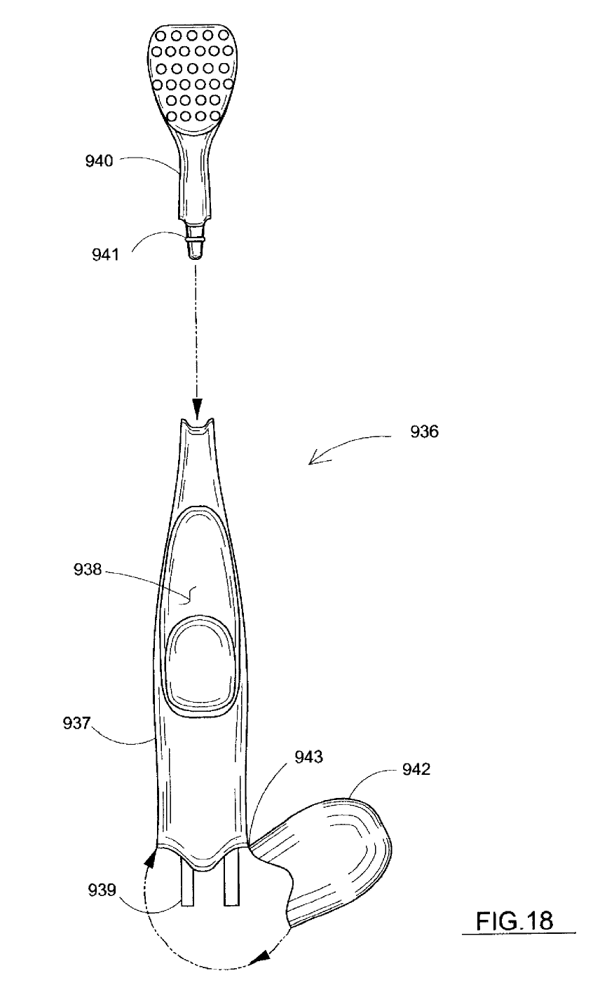

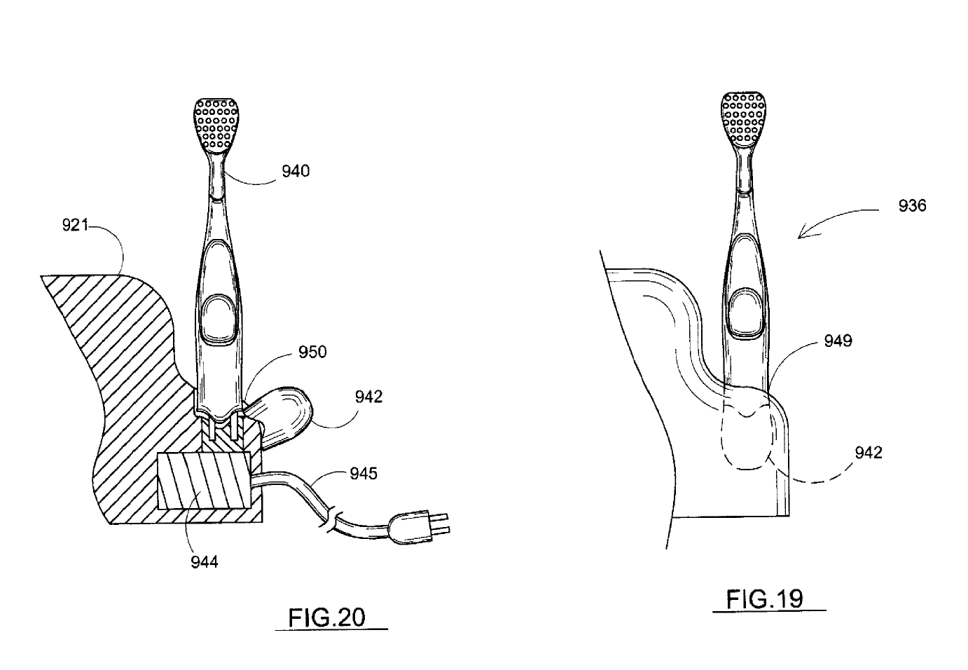

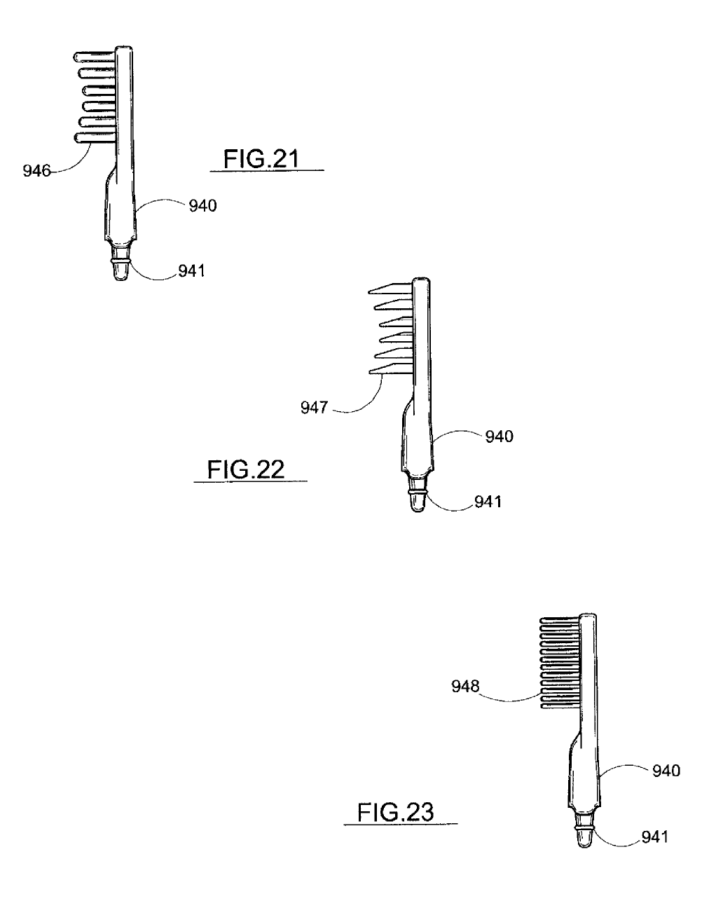

In one embodiment the present invention, as shown in FIGS. 8-23, the invention is a system that includes a flow switching valve 907 operatively associated with a standard faucet wherein said valve 907 incorporates a valve actuator input 911, a flow control valve 912 all within a valve body 906. Extending outward from valve body 906 is containment tube 901.

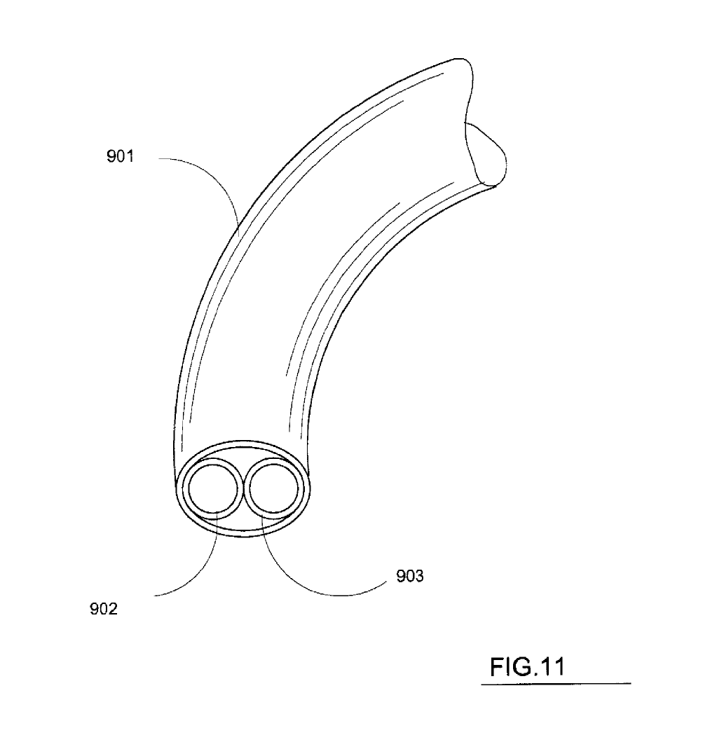

Tube 901 as best shown in FIG. 11 has water input tube 902 and a water discharge tube 903 incorporated therein. Container tube 901 attaches to tube spoiler body 916 and is operatively associated with vacuum mechanism plunger 917. Containment tube 901 continues and terminates on valve body 931. Valve body 931 includes an on/off valve 932, a selection ring valve 926, a poppet valve 928, a turbine housing 934 and a turbine port cover 933. Extending outward from valve body 931 is extension tip 600. Flow switching valve 907 is operatively associated with valve actuator input valve 910. Valve actuator input valve 910 is secured to the input from a water supply port 914 using a water import quick disconnect 911. When valve 907 is activated water is directed into water flow discharge port 905 and ultimately into containment tube 901. Water flowing into containment tube 901 can be regulated using flow control valve 912.

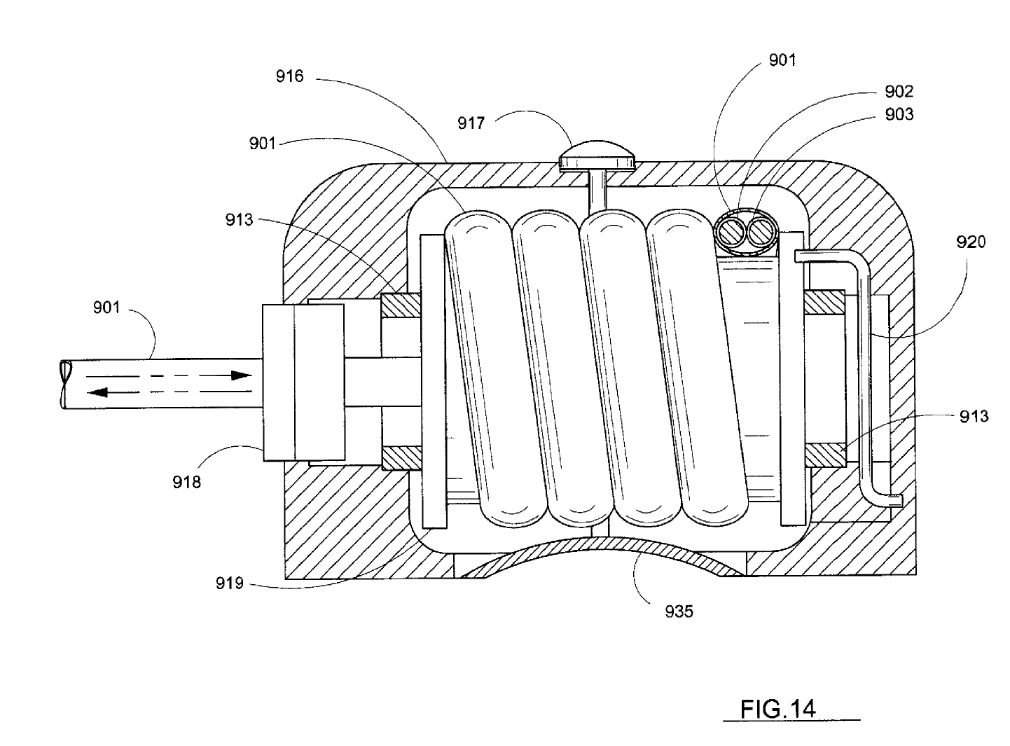

As generally understood, when flow control valve 912 is opened water will flow into water input tube 902 and water not being used flows through water discharge tube 903 and ultimately into valve actuator discharge port 909 and exits the system. Tube spoiler body 916 receives inlet water through containment tube 901 and has operatively associated therewith a vacuum mechanism plunger 917 that assists in spooling of containment tube 901 as best seen in FIG. 14.

Tube spooler body 916 has a rotary water connector 918 in which containment tube 901 is connected. A spool bearing 913 for supporting tube storage spool 919 and a return spring 920 for assisting in the spooling of containment tube 901. Containment tube 901 is further connected to selector valve body 931. Selector valve body 931 has incorporated therein an on/off valve that is placed in line with water input tube 902. Further there is an input selection port 927 a poppet valve 928 each in line with water input tube 902. Further incorporated within selector valve body 931 is a turbine discharge selection port 934 associated with ring valve 926 that will allow discharged water to flow through water flow discharge port 905 and be removed from selector valve body 931 through water discharge tube 903.

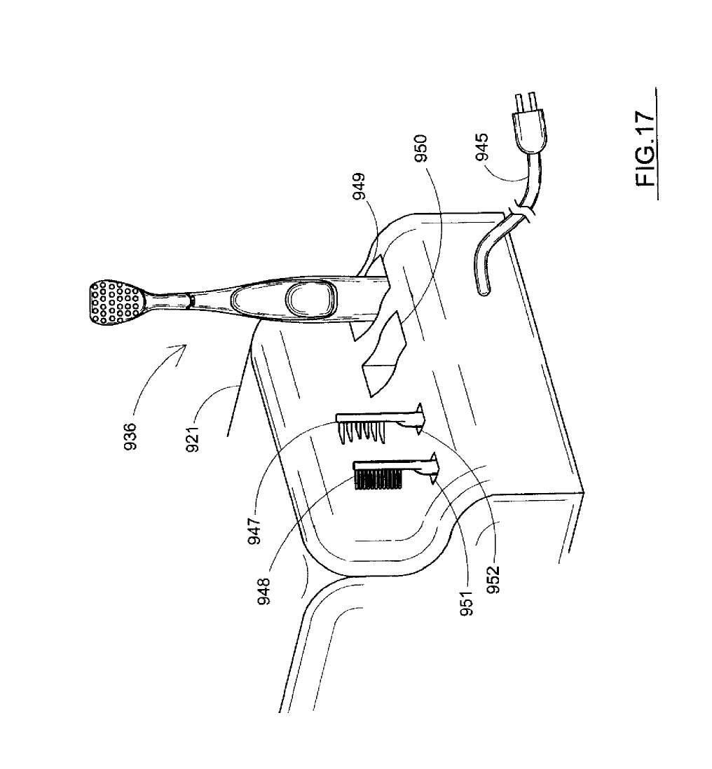

A water driven turbine 922 placed within selector valve body 931 is covered by turbine housing 934. The turbine is a hydraulic rotary turbine operatively associated such that rotational movement is applied to a device incorporated with extension 600. In one embodiment as shown in FIGS. 17-20 an electric toothbrush 936 is associated with system of the present invention.

Toothbrush 936 is placed in tool holder 921 in a dock position 949. Also incorporated with tool holder 921 is a charging position 950. The present invention further contemplates a first dock 951 and a second dock 952 for holding additional toothbrush heads. Toothbrush heads according to the present invention include, but are not limited to, a curved round end bristle brush 946 a curved chisel head bristle brush 947 and a flat fine bristle brush 948. A selected toothbrush bristle configuration is incorporated onto toothbrush head 940 having male quick disconnect 941 incorporated therewith.

In use, a user will initiate water from a water source and water will flow through water supply inlet 914 into the system of the present invention. Water flow switching valve 907 is actuated and water begins to flow through water input tube 902 and moves to control valve 912. Water continues pasted control valve 912 and reaches on/off valve 932. When on/off valve 932 is on the one position water will move to selector valve 926. Selector valve 926 will direct water either to poppet valve 928 which will produce an output to a water dispensing device whereby in a preferred embodiment the output can occur in spurts when poppet valve 928 is in the on position. When poppet valve 928 is in an off position the water output to the water-dispensing device is in a constant water flow. When selector valve 926 selects water directed to turbine, water powered turbine 934 is actuated. When using water powered turbine 934 the system is constructed and arranged such that water is directed ultimately to water discharge tube 903 and eventually directed out of the system. The system being constructed and arranged such that multiple devices are utilized. A user can use a standard water directional device for irrigation and the user can also actuate a hydraulic rotary turbine for use with a plurality of devices.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A system for providing water powered mechanical articles, said system comprising:
a selector valve operatively associated with a water inlet;
a containment tube having therein a separate water input tube and a separate water discharge tube;
a spooling apparatus for spooling said containment tube;
a hand-held selector valve having incorporated therein selection means for utilizing said system further constructed and arranged such that unexpelled water from said valve body is returned through said discharge tube incorporated said containment tube.

2. The system of claim 1 wherein said poppet valve controls the output of water from said water input tube such that said output is selected from either a steady stream or a pulsated stream.

3. The system of claim 2, wherein said output from said output valve is directed to said outlet device constructed and arranged to provide water to the oral cavity of a mammal.

4. The system of claim 1, where in said hydraulic rotary turbine is operatively associated with a mechanical tool and the motion of said turbine provides mechanical motion for said tool.

5. The system of claim 4 wherein said mechanical motion of said tool includes motion provided to a mechanical toothbrush head.
